(19) United States
(12) Patent Application Publication
(10) Pub. No.: US 2008/0029969 A1
(43) Pub. Date: Feb. 7, 2008

(54) Jet pump slip joint piston ring seal

(76) Inventor: Martin R. Torres, San Jose, CA (US)

Correspondence Address: MORRISS OBRYANT COMPAGNI, P.C., 734 EAST 200 SOUTH, SALT LAKE CITY, UT, 84102, US

(21) Appl. No.: 11/888,781

(22) Filed: Aug. 2, 2007

Related U.S. Application Data
(60) Provisional application No. 60/834,927, filed on Aug. 2, 2006.

(51) Int. Cl. B21D 53/84; F02F 5/00

(52) U.S. Cl. 277/434; 29/888.3

(57) ABSTRACT

A slip joint sealing device for use in piping systems, and particularly in reactor pressure vessels, seals the slip joint between two adjacent pipe surfaces using one or more piston rings positioned in a circumferential groove machined into the outer surface of an inner positioned pipe at the slip joint, and an optional circumferential spring may be employed to retain the piston ring in contact with the inner surface of the adjacent pipe at the slip joint.

### CROSS-REFERENCE TO RELATED APPLICATION

This application is a non-provisional application claiming priority to provisional patent application Ser. No. 60/834,927 filed Aug. 2, 2006.

### BACKGROUND OF THE INVENTION

1. Field of the Invention

This invention relates generally to tubular jet pumps used in various industries to transport and/or circulate cooling liquid in heat-generating systems, such as nuclear reactors and hydroelectric generation systems. More particularly, this invention relates to means for reducing the leakage and vibration in the slip joints of such jet pumps.

2. Description of Related Art

Pipes, tubes and cylinders are used to transport a variety of fluids, such as water, oil, and liquid chemicals in various industries including the nuclear industry, the electric power industry, such as for internal components of heat exchangers, the hydroelectric power generation industry, the petroleum industry, such as piping used in refining of oil, the chemical industry, such as the piping used in processes for making chemical based products, and the space industry, for spacecraft heat exchangers and other similar devices.

Oftentimes, the piping components in such industrial systems are submerged in the same fluids which the piping is transporting. As an example, the tubular components that make up a jet pump assembly are housed within a nuclear reactor pressure vessel and reside in the fluid that the jet pump is used to transport. That is, the jet pump assembly transports the cooling water to the reactor core, but the jet pump assembly itself is also submerged in that same fluid. The pipes and tubes that comprise such submerged systems are supported within the surrounding structures by support or restraining apparatus. The surrounding structures (e.g., a reactor vessel) may be of a different material, such as carbon steel (reactor pressure vessel), than the material that the piping is made of, such as stainless steel (jet pump assembly) with different thermal coefficients of expansion. In order to accommodate the different amounts of axial thermal expansion that will occur between the tubes and the surrounding support structure at higher operating temperatures, designers install slip joints along the piping to minimize thermal stress build up within the tubes.

Recent engineering experience has shown that if a sufficient pressure gradient exists across these slip joint interfaces, the connecting tubular components may incur detrimental flow-induced vibration, and failure results from either excessive wear or fatigue of the piping material or support/restraining apparatus. One exemplar system where such failure occurs is the jet pump assemblies used in nuclear reactors.

A reactor pressure vessel (RPV) of a boiling water reactor (BWR) typically has a generally cylindrical shape and is closed at both ends with typically a bottom head and a removable top head. A top guide typically is spaced above a core plate within the RPV and a core shroud, typically surrounds the core and is supported by shroud support structure. The shroud has a generally cylindrical shape and surrounds both the core plate and the top guide. A space, or annulus, is located between the cylindrical reactor pressure vessel and the cylindrically shaped shroud. A plurality of jet pumps are positioned within the annulus. An typical example of such reactor cores is disclosed in U.S. Pat. No. 4,675,149 to Perry, et al.

In a BWR, the hollow tubular jet pumps positioned within the shroud annulus provide the required reactor core water flow. Examples of such jet pump assemblies are disclosed in U.S. Pat. No. 6,587,535 to Erbes, et al. The upper portion of the jet pump, known as the inlet mixer, is laterally positioned and supported against opposing contacts within the restrainer bracket by a gravity-actuated wedge and two set screws. The restrainer brackets support the inlet mixer by attaching to the adjacent jet pump riser pipe.

The lower portion of the jet pump, known as the diffuser, is coupled to the inlet mixer by a slip joint. This construction facilitates the disassembly and repair of the jet pump. The slip joint between the jet pump inlet mixer and the jet pump diffuser collar has about a 0.015 inch diametral operating clearance which accommodates the relative axial thermal expansion movement between the upper and lower parts of the jet pump and permits leakage flow from the driving pressure inside the pump.

Excessive leakage flow, however, can cause oscillation motion in the slip joint, which is a source of detrimental vibration excitation in the jet pump assembly. The slip joint leakage flow rate can increase due to single loop operation, increased core flow, or deposition of jet pump detritus, or crud. Additional detrimental conditions that may lead to damaging vibration between the inlet mixer and diffuser of the jet pump assembly are well-known, such as loss of the set screw support in a jet pump assembly as described in U.S. Pat. No. 6,394,765 to Erbes, et al.

In addition to affected set screw gaps, thermal and pressure displacements of the shroud and the pressure vessel can diminish alignment interaction loads in the jet pump assembly which are beneficial in restraining vibration. The resultant increased vibration levels and corresponding vibration loads on the piping and supports can cause jet pump component degradation from wear and fatigue.

High levels of flow-induced vibration (FIV) are possible in some jet pump designs at some abnormal operational conditions having increased leakage flow rates. Reducing leakage flow through the slip joint prevents or reduces oscillatory slip joint motion and suppresses FIV. Prior efforts to reduce the leakage flow rate in jet pump slip joints have been disclosed in U.S. Pat. No. 6,394,765, which discloses an external clamp apparatus for laterally stabilizing the slip joint; U.S. Pat. No. 6,438,192 to Erbes, et al., which discloses a split ring seal and latch assembly positioned at the upper end of the diffuser tube to stabilize the inlet mixer; U.S. Pat. No. 6,450,774 to Erbes, et al., which discloses a device for producing a lateral support load on the slip joint by causing an ovate deformation in the diffuser when attaching it to the inlet mixer; and U.S. Pat. No. 6,587,535 to Erbes, et al., which discloses a labyrinth seal in the slip joint for reducing slip joint leakage flow.

Each of the previously disclosed inventions has demonstrated some characteristic which has rendered the device or method insufficient in either producing effective reduction of slip joint-induced vibration or reduction of flow rate leakage through the slip joint. In addition, those devices and methods that impose a lateral force on the slip joint also prevent axial movement in the slip joint, which does not properly allow for thermal expansion in the slip joint.

It would be advantageous in the industry to provide a device and method for sealing the slip joint between pipes, such as in a jet pump assembly, so that the leakage flow rate is reduced or eliminated, and so that vibration between the pipes is effectively reduced or eliminated. It would also be advantageous to provide a seal for the slip joint between pipes which allows for axial movement between the pipes to accommodate thermal expansion in the pipes and which is easy to install and maintain.

### BRIEF SUMMARY OF THE INVENTION

In accordance with the present invention, a device is provided for sealing the slip joint between pipes in a manner that advantageously eliminates leakage flow rates in the slip joint, thereby effectively reducing or eliminating vibration in the slip joint, and which is structured to allow axial movement between the pipes to enable thermal expansion between the pipes and or the supporting structure. While the present invention is adaptable for use in any pipe system where a slip joint is provided between pipes, the invention is described herein with respect to jet pump assemblies of nuclear reactors by way of example.

The slip joint sealing device of the present invention comprises a piston ring which is sized to be received in a circumferential groove formed in the outer surface of the inlet mixer in a jet pump. The piston ring effectively seals the gap between the outer surface of the inlet mixer and the adjacent inner surface of the diffuser. More than one piston ring may be used to provide the seal and each ring is received in its own circumferential groove formed in the outer surface of the inlet mixer.

The slip joint sealing device may further include a circumferential spring which is positioned within the circumferential groove. The circumferential spring acts to force the piston ring outwardly from the outer surface of the inlet mixer to make better contact with the inner surface of the diffuser.

A retaining pin may be used to retain the piston ring or rings within the circumferential groove or grooves during installation or assembly of the jet pump. Once the inlet mixer is positioned in the diffuser, the retainer pin is removed to allow the piston ring to expand outwardly from the circumferential groove to make contact with the inner wall of the diffuser.

A first method is described for initially installing the slip joint sealing device of the present invention in a jet pump prior to operation of the reactor, when the reactor and jet pump are in a non-irradiated state. A second method is described for installing the slip joint sealing device of the present invention after the reactor has been in operation.

The slip joint sealing device of the present invention has the advantage of not adding mass to the jet pump assembly and does not change the inherent dynamic properties of the mass and stiffness of the jet pump assembly. As a result, the vibration response of the jet pump due to flow-induced vibration forces other than the slip joint FIV device would remain the same.

### BRIEF DESCRIPTION OF THE SEVERAL VIEWS OF THE DRAWINGS

In the drawings, which illustrate what is currently considered the best mode for carrying out the invention:

FIG. 1 is a partial, schematic view of a nuclear reactor, shown in cutaway, illustrating a conventional jet pump assembly positioned in the annulus of the reactor;

FIG. 2 is an enlarged view in cross section of a slip joint between the inlet mixer and diffuser of a jet pump;

FIG. 3 is an enlarged view in cross section of a slip joint in which the slip joint sealing device of the present invention is installed; and

FIG. 4 is an enlarged view in cross section of a slip joint at installation of the sealing device of the present invention.

### DETAILED DESCRIPTION OF THE INVENTION

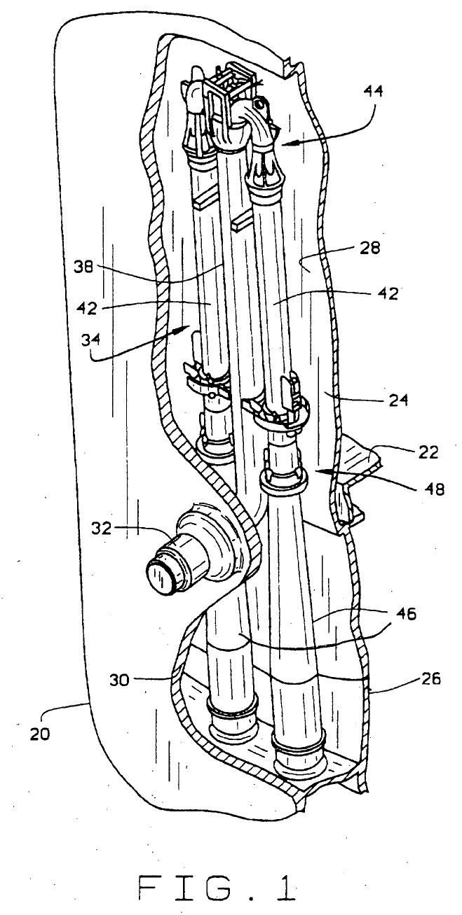

FIG. 1 is a schematic illustration of a portion of a conventional reactor pressure vessel (RPV) 20 for a boiling water reactor. Such reactors are previously described in U.S. Pat. No. 4,675,149 and U.S. Pat. No. 6,587,535, the disclosures of which are incorporated herein. The RPV 20 has a generally cylindrical shape and is closed at one end by a bottom head (not shown) and at its other end by removable top head (not shown). A top guide (not shown) is spaced above a core plate 22 within RPV 20. A shroud 24 surrounds the core plate 22 and is supported by a shroud support structure 26. An annulus 28 is formed between the shroud 24 and sidewall 30 of the RPV 20.

An inlet nozzle 32 extends through the sidewall 30 of the RPV 20 and is coupled to a jet pump assembly 34. The jet pump assembly 34 includes a riser pipe 38 and a plurality of inlet mixers 42 connected to the riser pipe 38 by a transition assembly 44. A diffuser 46 is connected to and positioned below each of the inlet mixers. A slip joint 48 couples each inlet mixer 42 to a corresponding diffuser 46.

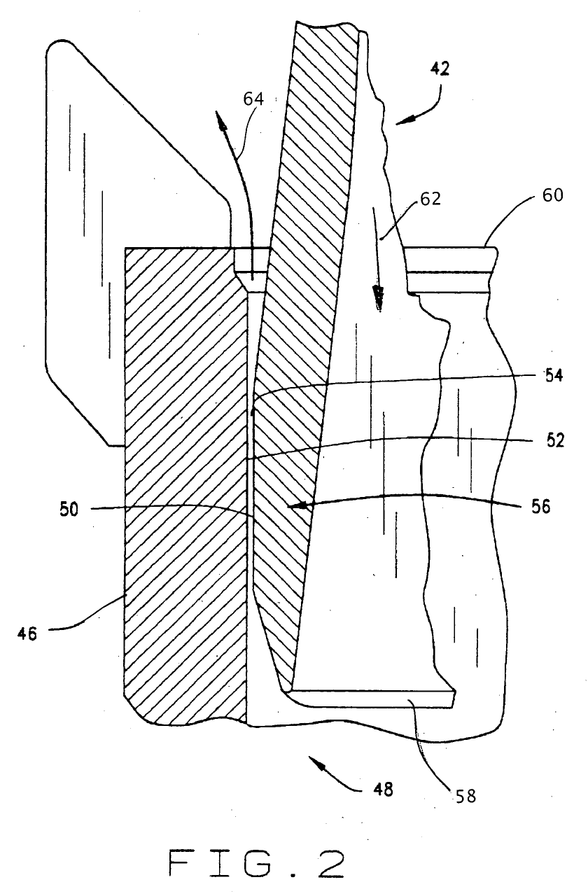

FIG. 2 is illustrates in an enlarged cross sectional view the relative positioning of an inlet mixer 42 and diffuser 46. It can be seen that the inlet mixer 42 is generally cylindrical and has an outer surface 50. The inlet mixer 42 has an open end 58 which is received in an open end 60 of the generally cylindrical diffuser 46. The diffuser 46 has an inner surface 52 positioned adjacent to the outer surface 50 of the inlet mixer 42. An operational clearance 54 exists at an interface 56 between the outer surface 50 of the inlet mixer 42 and the inner surface 52 of the diffuser 46. When fluid is pumped through the inlet mixer 42 into the diffuser 46, in the direction of arrow 62, leakage of some of the fluid occurs through the clearance 54 in the slip joint 48, as shown by arrow 64.

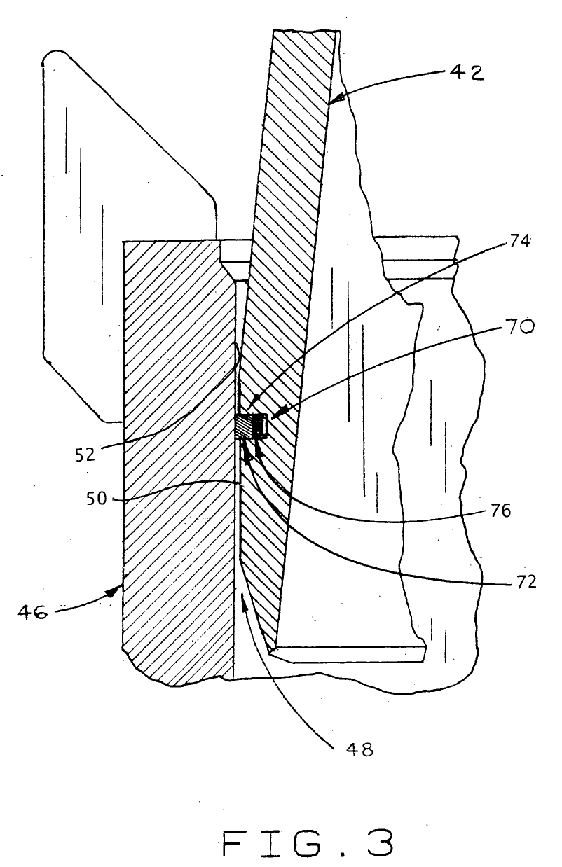

FIG. 3 illustrates the slip joint 48 between an inlet mixer 42 and diffuser 46 where the slip joint sealing device 70 of the invention is installed in the slip joint 48 to eliminate leakage. The sealing device 70 of the invention comprises a piston ring 72 that is positioned in a circumferential groove 74 that is machined into the outer surface 50 of the inlet mixer at the slip joint 48. The piston ring is flexible and expandable such that when positioned in the circumferential groove 74, the piston ring extends outwardly from the circumferential groove to contact the adjacent inner surface 52 of the diffuser. While one piston ring 72 and circumferential groove 74 are illustrated, it is understood that multiple circumferential grooves and accompanying piston rings 72 may be used in the sealing device 70.

An optional circumferential spring 76 is shown in FIG. 3 to be positioned in the circumferential groove 74 between the circumferential groove 74 and the piston ring 72. The circumferential spring 76 provides biasing means between the circumferential groove 74 and piston ring 72 to aid in pushing the piston ring 72 outwardly to make contact with the inner surface 52 of the diffuser.

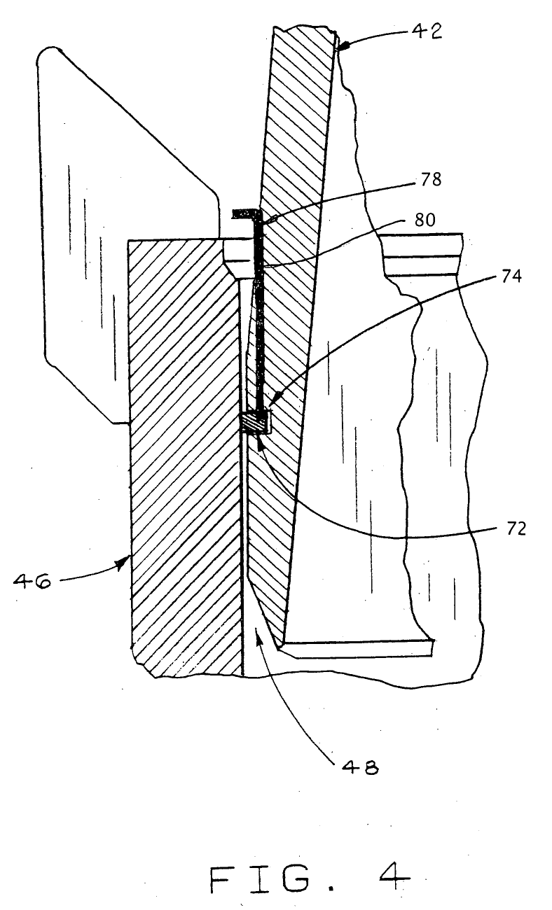

FIG. 4 illustrates a means for installing the piston ring 72 in the circumferential groove 74 using a retaining pin 78 to hold the piston ring 72 within the circumferential groove 74 while the inlet mixer 42 is positioned in the diffuser 46. The retaining pin 78 is received within an axial groove 80 that is machined into the outer surface 50 of the inlet mixer 42 at one azimuth of the slip joint 48. The axial groove 80 is positioned to intersect the circumferential groove 74 so that when the retaining pin 78 is positioned in the axial groove 80, the retaining pin 78 contacts the piston ring 72 and retains it within the circumferential groove 74. More than one retaining pin may be used at various points around the slip joint 48 to retain the piston ring 72.

The slip joint sealing device of the present invention may be installed either when the jet pump assembly is new (i.e., non-irradiated) and being positioned in the RPV, or the invention can be installed as a retrofit to an existing RPV. In the first method of installation, the circumferential groove is machined into the outer surface of the inlet mixer and the axial groove is also machined into the outer surface of the inlet mixer. If employed in the sealing device, the circumferential spring is first positioned in the circumferential groove, followed by placement of the piston ring in the circumferential groove.

A standard compression sleeve is positioned about the outer surface of the inlet mixer at the slip joint and the retaining pin is then inserted into the axial groove and positioned to engage the piston ring. The retaining pin is positioned to prevent the piston ring from expanding beyond the diameter of the outer surface of the inlet mixer after the compression sleeve is removed. At positioning of the inlet mixer in the diffuser, the compression sleeve is removed by known means. The retaining pin may then be removed using known tools and methods. Alternatively, axial movement resulting from the difference in thermal expansion between the stainless steel jet pump and the carbon steel RPV during operation of the RPV will automatically activate the captured retaining pin. The retaining pin is designed to be permanently captured within the inlet mixer and will not become a loose part.

In the later method of installing the slip joint sealing device of the invention after the RPV has been in operation, the inlet mixer is removed from the diffuser by means known in the industry. However, because the jet pump has been irradiated during operation of the RPV, the inlet mixer must be shielded within a water source to protect the workers who are handling the jet pump components. The circumferential groove is machined in the outer surface of the inlet mixer at the slip joint using tools that may be used underwater. The axial groove is also machined in the outer surface of the inlet mixer. The installation of the optional circumferential spring, the piston ring and the retaining pin follow the procedure described with respect to a new, non-irradiated installation.

The slip joint sealing device described herein restricts leakage flow between the inlet mixer and diffuser at the slip joint, and thereby prevents oscillating motion or vibration in the jet pump system occasioned by high level flow-induced vibration of the jet pump assembly and its components. Additionally, the presence of the jet pump slip joint seal device at the slip joint provides a damping resistance to oscillating motion. The present invention also enables axial movement of the jet pump components due to varying thermal expansion rates in the components, while maintaining a comprehensive seal at the slip joint. The number and positioning of the piston rings may vary depending on the particular installation specifications and can be adapted to any variety of piping systems. Therefore, reference herein to particular embodiments and structures is by way of example only and not by way of limitation.

What is claimed is:

1. A slip joint sealing device for a jet pump assembly having an inlet mixer positioned within a diffuser with a slip joint therebetween, comprising:
a circumferential groove formed in the an outer surface of an inlet mixer at the slip joint between the inlet mixer and the diffuser; and
a piston ring positioned in said circumferential groove and oriented for contact with the inner surface of the diffuser at the slip joint to eliminate flow leakage in the slip joint.

2. The slip joint sealing device of claim 1 further comprising an axial groove formed in the outer surface of the inlet mixer at the slip joint, said axial groove being positioned to intersect with said circumferential groove and sized to receive a retaining pin for engagement with said piston ring positioned in said circumferential groove.

3. The slip joint sealing device of claim 1 further comprising a circumferential spring positioned in said circumferential groove between said circumferential groove and said piston ring to provide biasing force between said circumferential groove and said piston ring.

4. The slip joint sealing device of claim 3 further comprising an axial groove formed in the outer surface of the inlet mixer at the slip joint, said axial groove being positioned to intersect with said circumferential groove and sized to receive a retaining pin for engagement with said piston ring positioned in said circumferential groove.

5. The slip joint sealing device of claim 1 further comprising a plurality of circumferential grooves with a piston ring positioned in each said circumferential groove of said plurality, each said circumferential groove of said plurality being formed at the slip joint between the inlet mixer and diffuser.

6. The slip joint sealing device of claim 5 wherein each said circumferential groove of said plurality has a circumferential spring positioned in said circumferential groove to provide a biasing force between said circumferential spring and said piston ring.

7. A method of installing a slip joint sealing device in a jet pump assembly having an inlet mixer positionable within a diffuser, comprising:
forming a circumferential groove in an outer surface of a inlet mixer of a jet pump at the slip joint;
inserting a piston ring within said circumferential groove;
positioning a compression sleeve about the outer surface of the inlet mixer at the circumferential groove to retain said piston ring in said circumferential groove; positioning the inlet mixer within the diffuser;
removing the compression sleeve from about the outer surface of the inlet mixer; and
positioning the inlet mixer within the diffuser to provide contact between said piston ring and an inner surface of the diffuser.

8. The method of claim 7 further comprising forming at least one axial groove in the outer surface of the inlet mixer at the slip joint and positioning said axial groove to intersect with said circumferential groove, and inserting a retaining pin within said axial groove to engage said piston ring in the circumferential groove after positioning of the compression sleeve about the inlet mixer.

9. The method of claim 8 further comprising removing the retaining pin from the axial groove after removing the compression sleeve.

10. The method of claim 7 wherein said method is performed underwater.

11. The method of claim 8 wherein said method is performed underwater.
